(19) United States
(12) Patent Application Publication
(10) Pub. No.: US 2011/0058376 A1
(43) Pub. Date: Mar. 10, 2011

(54) LED illumination device capability of increasing brightness of illumination

(76) Inventors: Hung Jie Lin, Sinjhuang City (TW); Yen Wei Pen, Sinjhuang City (TW)

(21) Appl. No.: 12/703,766

(22) Filed: Feb. 11, 2010

(30) Foreign Application Priority Data
Sep. 4, 2009 (TW) 098129912

(51) Int. Cl. F21V 29/00

(52) U.S. Cl. 362/294

(57) ABSTRACT

An LED illumination device capability of increasing brightness of illumination includes a heat sink base, an LED illumination module and a transparent board. The heat sink base has a bottom board and two reflector boards arranged at the both sides of the bottom to form an accommodating space, which has an open end. The LED illumination module is arranged at the bottom board of the heat sink base, and is located within the accommodating space. The transparent board is mounted at the open end of the accommodating space to cover the accommodating space of the heat sink base.

### FIELD OF THE INVENTION

The present invention relates to an LED illumination device capability of increasing brightness of illumination, and in particular to an LED lamp capable of assembling conveniently

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

As is generally known in the art, use has been made of varying kinds of illumination lamps for lightening or illuminating objects at night or indoors. Such illumination lamps are supplied with electric energy from a power source and convert the electric energy to light energy, thereby producing a beam of light for illumination. Typical examples of the illumination lamps include a glow lamp and a fluorescent lamp.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

### SUMMARY OF THE INVENTION

An object of the present invention is to provide an LED illumination device capability of increasing brightness of illumination.

To achieve the above-mentioned object, the present invention includes a heat sink base, an LED illumination module and a transparent board. The heat sink base has a bottom board and two reflector boards arranged at the both side of the bottom to form an accommodating space, which has an open end. The LED illumination module is arranged at the bottom board of the heat sink base, and is located within the accommodating space. The transparent board is mounted at the open end of the accommodating space to cover the accommodating space of the heat sink base.

### BRIEF DESCRIPTION OF THE DRAWINGS

FIG. 1 is a cross-sectional view of assembly drawing of an LED illumination device capability of increasing bright of illumination of the present invention

FIG. 2 is a cross-sectional of the present invention.

### DETAILED DESCRIPTION OF THE INVENTION

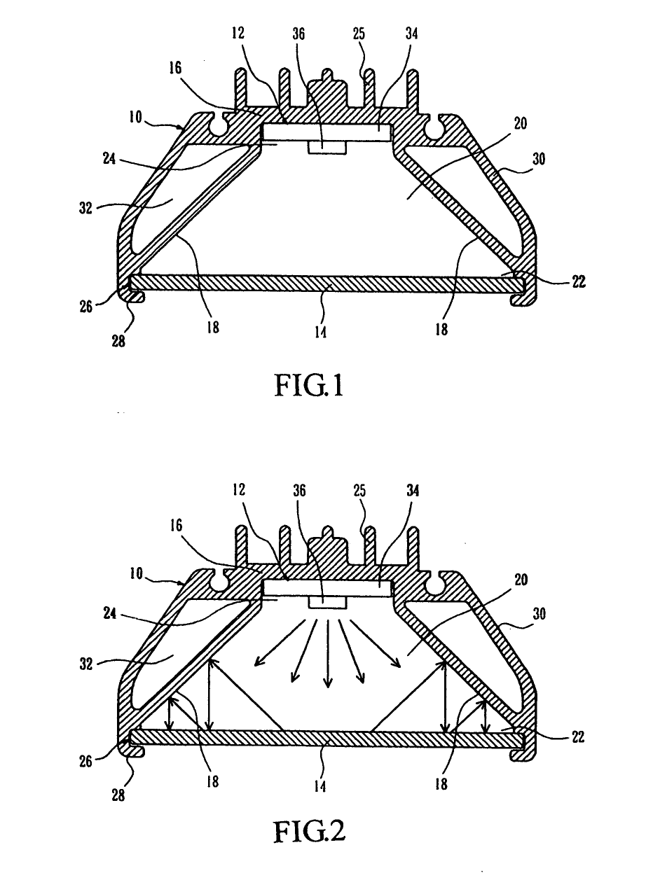

Referring to FIG. 1-FIG. 2, an LED illumination device capability of assembling conveniently of the present invention includes a heat sink base 10, an LED illumination module 20 and a transparent board 40. Wherein

The heat sink base 10 has a bottom board 16 and two reflector boards 18 located on the both sides of the bottom board 16 to form an accommodating space 20, which has an open end 22. The bottom board 16 is formed with a cavity 24 and a plurality of heat sink sheets 25 opposite to the cavity 24, wherein the two reflector boards 18 are extended inclined outwardly from the cavity 24 of the bottom board 16, and is formed with correspond to guide slot 26, the external side of the two reflector boards 16 are formed with reinforcement board 30 individually.

The LED illumination module 12 has a print circuit board 34 and a plurality of LED 36 mounted on the print circuit board 34, wherein the print circuit board 34 is located within the cavity 24 of the bottom board 16 of the heat sink base 10.

The transparent board 14 is inserted within the guide slot 28 of the two reflectors 18 to cover the open end 22 of the accommodating space 20 for encapsulating the LED illumination module 12, so that the emitted light from the illumination module 12 may illuminated via the transparent board 14.

Therefore, the two reflector boards 18 may be reflected the emitted light from the illumination module to increase the brightness of illumination.

While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination device capability of increasing brightness of illumination, comprising:
A heat sink base having a bottom board and two reflector board arranged at the both sides of the bottom to form an accommodating space, which has an open end;
An LED illumination module arranged at the bottom board of the heat sink base, and located within the accommodating space; and
A transparent board mounted at the open end of the accommodating space to cover the accommodating space of the heat sink base.

2. The LED illumination device capability of increasing brightness of illumination according to claim 1, wherein the bottom of the heat sink base is formed with a cavity, so as to the LED illumination module is located within the cavity of the heat sink base.

3. The LED illumination device capability of increasing brightness of illumination according to claim 1, wherein the external side of the bottom of the heat sink base is formed with a plurality of heat sink sheets.

4. The LED illumination device capability of increasing brightness of illumination according to claim 2, wherein the two reflector boards are extended outwardly from the cavity of the bottom board of the heat sink base.

5. The LED illumination device capability of increasing brightness of illumination according to claim 1, wherein the two reflector board are formed with correspond to guide slot, so as to the transparent board is guided into the guide slots for covering the open end of the accommodating space.

6. The LED illumination device capability of increasing brightness of illumination according to claim 1, wherein the external side of the two reflector boards are formed with reinforcement board individually.
